(19) United States
(12) Patent Application Publication
(10) Pub. No.: US 2025/0291182 A1
(43) Pub. Date: Sep. 18, 2025

(54) VEHICLE PROJECTION DISPLAY DEVICE

(71) Applicant: Nippon Seiki Co., Ltd., Niigata (JP)

(72) Inventor: Kenzo Adachi, Niigata (JP)

(21) Appl. No.: 19/065,393

(22) Filed: Feb. 27, 2025

(30) Foreign Application Priority Data
Mar. 18, 2024 (JP) 2024-041830

(51) Int. Cl. G02B 27/01

(52) U.S. Cl. CPC G02B 27/0101; G02B 2027/0138

(57) ABSTRACT

A display device includes: a cover panel that changes a height in a front-rear direction, and has an emission surface that emits display light; infrared light sources that emit infrared light, and an infrared sensor that detects the infrared light from the infrared light source and reflected infrared light from an object on the emission surface. The infrared light source is arranged lateral to the emission surface in a vehicle width direction to be aligned with the infrared sensor in the front-rear direction, and is provided corresponding to a position at a first height of the emission surface in the front-rear direction. The infrared light source and the infrared sensor are located to be opposed to each other via the emission surface in the vehicle width direction, and are provided corresponding to a position at a second height, which is lower than the first height, of the emission surface.

### TECHNICAL FIELD

The present disclosure relates to a vehicle projection display device.

### BACKGROUND ART

A head-up display device described in Patent Document 1 includes a light source that emits light and a display unit that generates display light using the light, and displays a virtual image to a viewer by reflecting the display light on a front windshield.

### PRIOR ART DOCUMENT

### Patent Document

Patent Document 1: Japanese Unexamined Patent Publication No. 2023-73536

### SUMMARY OF INVENTION

### Technical Problem

In the configuration described in above Patent Document 1, when an object falls onto an emission surface that emits the display light in the head-up display device, the display light is blocked by the object, thereby decreasing the display quality of the virtual image. Thus, the object being located on the emission surface has been required to be detected with a simple configuration and high accuracy.

The present disclosure has been made in view of the above-described circumstances, and an object of the present disclosure is to provide a vehicle projection display device capable of detecting an object being located on an emission surface with a simple configuration and high accuracy.

### Solution to Problem

In order to achieve the above-described object, a vehicle projection display device according to the present disclosure is a vehicle projection display device that displays an image by projecting display light from an emission port onto a projection target member, including: a translucent cover panel through which the display light passes, which changes a height with respect to a front-rear direction of a vehicle, has an emission surface that emits the display light toward the projection target member, and is formed in a plate shape for closing the emission port; first and second infrared light sources that emit infrared light along the emission surface; and an infrared sensor that can detect the infrared light directly reaching from the first infrared light source and reflected infrared light obtained by reflecting the infrared light from the second infrared light source by an object on the emission surface, in which the second infrared light source is arranged lateral to the emission surface in a width direction orthogonal to the front-rear direction so as to be aligned with the infrared sensor in the front-rear direction, and is provided corresponding to a position at a first height of the emission surface in the front-rear direction, and the first infrared light source and the infrared sensor are located so as to be opposed to each other via the emission surface in the width direction, and are provided corresponding to a position at a second height, which is lower than the first height, of the emission surface in the front-rear direction.

### Advantageous Effects of Invention

According to the present disclosure, an object being located on an emission surface can be detected with a simple configuration and high accuracy.

### BRIEF DESCRIPTION OF DRAWINGS

FIG. 1 is a schematic diagram of a vehicle on which a display device according to an embodiment of the present disclosure is mounted.

FIG. 2 is a schematic plan view of the display device according to the embodiment of the present disclosure.

FIG. 3 is a schematic plan view of the display device according to the embodiment of the present disclosure.

FIG. 4 is a schematic cross-sectional view of the display device according to the embodiment of the present disclosure as viewed from the front.

FIG. 5 is a schematic cross-sectional view of the display device according to the embodiment of the present disclosure as viewed from the side.

FIG. 6 is a schematic plan view of the display device according to the embodiment of the present disclosure.

FIG. 7 is a schematic cross-sectional view of the display device according to the embodiment of the present disclosure as viewed from the front.

FIG. 8 is a schematic cross-sectional view of the display device according to the embodiment of the present disclosure as viewed from the side.

FIG. 9 is a flowchart illustrating a determination processing procedure according to the embodiment of the present disclosure.

FIG. 10 is a schematic diagram of a vehicle on which a head-up display device according to a modification of the present disclosure is mounted.

### DESCRIPTION OF EMBODIMENTS

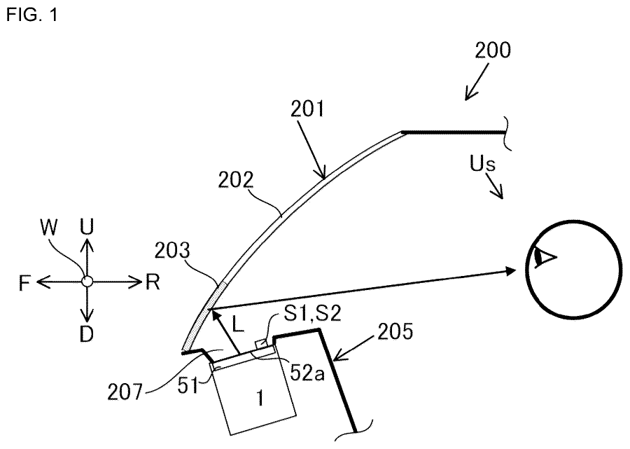

A vehicle projection display device according to an embodiment of the present disclosure will be described with reference to the drawings. As illustrated in FIG. 1, a vehicle projection display device 1 is mounted in a dashboard 205 of a vehicle 200. The display device 1 displays a projection image including vehicle information such as a vehicle speed such that a viewer Us can visually recognize the projection image by projecting display light L onto a windshield 201 that is a projection target member. That is, the display device 1 is a windshield display (WSD) in which the display light L from a display panel 51, which will be described below, of the display device 1 is directly projected onto the windshield 201.

The windshield 201 includes a light transmitting portion 202 and a light shielding portion 203. The light transmitting portion 202 is a portion that enables the viewer Us in a vehicle compartment to visually recognize the actual scenery outside the vehicle compartment. The light shielding portion 203 is located at a lower end portion of the light transmitting portion 202, and is formed in a region of the windshield 201 on the side of the dashboard 205. The light shielding portion 203 is formed by black ceramic printing. The display device 1 projects the display light L onto the light shielding portion 203 to display a projection image with the light shielding portion 203 as a background.

Specifically, an emission port 207 opposed to the windshield 201 is formed in the dashboard 205. The display device 1 is mounted in the dashboard 205 such that the display light L passes through the tubular emission port 207.

There is a possibility that objects S1, S2 placed on the dashboard 205 fall into the emission port 207 due to the inertia force or the like (including the inertia force generated by acceleration associated with traveling of the vehicle 200 (including collisions and vibrations due to accidents), the gravity whose direction changes with a change in the vehicle attitude, and the like). The display device 1 is configured to be able to determine whether the objects S1, S2 are located on an emission surface 52a that emits the display light L.

In the following description, a front direction F, a rear direction R, an up direction U, a down direction D, and a vehicle width direction W, which is a right-left direction, are defined on the basis of the viewpoint of the viewer Us.

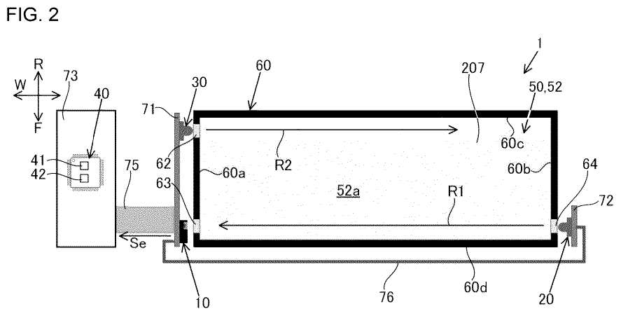

As illustrated in FIG. 2, the display device 1 includes an infrared sensor 10, a first infrared light source 20, a second infrared light source 30, a control unit 40, a display 50, a case 60, substrates 71, 72, 73, and cables 75, 76.

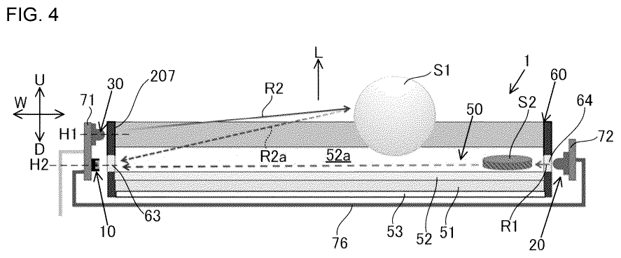

As illustrated in FIG. 4, the display 50 includes the display panel 51, a cover panel 52, and a backlight 53. The display panel 51, the cover panel 52, and the backlight 53 have a rectangular plate shape that is long in the vehicle width direction W, and are stacked in the up-down direction U, D.

The display panel 51 is a thin film transistor (TFT) type liquid crystal panel. The display panel 51 displays an image including vehicle information such as a vehicle speed under the control of the control unit 40. The display panel 51 receives illumination light from the backlight 53 while displaying the image, thereby emitting the display light L representing the image.

The backlight 53 is located in the down direction D from the display panel 51, and illuminates the display panel 51 under the control of the control unit 40.

The cover panel 52 is located on the upper surface (image display surface) of the display panel 51, and is made of a resin material or a glass material having optical transparency, through which light passes. The upper surface of the cover panel 52 is the emission surface 52a that emits the display light L from the display panel 51 after the display light L passes through the cover panel 52. As illustrated in FIG. 1, the emission surface 52a is a surface of the display device 1, which is exposed to the projection target member (windshield 201). The emission port 207 is located on the outer peripheral side of the emission surface 52a. The emission port 207 is formed as a tubular internal space penetrating in the up-down direction U, D.

The emission surface 52a is a flat surface, in the present example, a rectangular flat surface that is long in the vehicle width direction W, and is uniformly inclined with respect to the front-rear direction F, R. Specifically, the emission surface 52a is inclined toward the down direction D as the emission surface 52a is closer to the front direction F. That is, the height of the emission surface 52a becomes lower as the emission surface 52a is closer to the front direction F. The emission surface 52a is formed along the vehicle width direction W.

The present invention is not limited to the present embodiment, and the emission surface 52a may be inclined with respect to the vehicle width direction W. In this case, for example, the emission surface 52a may be inclined toward the down direction D as the emission surface 52a is closer to the vehicle outer side in the vehicle width direction W. Moreover, the emission surface 52a may be inclined toward the down direction D as the emission surface 52a is closer to the rear direction R.

The case 60 is formed of a light-shielding resin or metal in a frame shape (in the present example, a rectangular frame shape), and is formed to surround the outer periphery of the display panel 51, the cover panel 52, and the backlight 53.

As illustrated in FIG. 2, the case 60 includes a pair of short side walls 60a, 60b and a pair of long side walls 60c, 60d. The pair of short side walls 60a, 60b extends in the front-rear direction F, R, and is located so as to be opposed to each other in the vehicle width direction W. The pair of long side walls 60c, 60d is longer than the short side walls 60a, 60b, extends in the vehicle width direction W, and is located so as to be opposed to each other in the front-rear direction F, R.

The case 60 includes infrared transmitting portions 62, 63, 64 as windows that partially cause infrared light to pass therethrough. The infrared transmitting portions 62, 63, 64 are fitted into holes penetrating the walls 60a to 60d of the case 60 in the thickness direction. The infrared transmitting portions 62, 63, 64 cause infrared light to pass therethrough in the thickness direction of the infrared transmitting portions 62, 63, 64 such that the infrared light can move between the internal space and the external space of the case 60.

The infrared transmitting portion 62 is located at an end portion of the short side wall 60a in the rear direction R. The infrared transmitting portion 63 is located at an end portion of the short side wall 60a in the front direction F. The infrared transmitting portion 64 is located at an end portion of the short side wall 60b in the front direction F. The infrared transmitting portion 63 and the infrared transmitting portion 64 are located so as to be opposed to each other in the vehicle width direction W.

The first infrared light source 20 is a light emitter that emits infrared light toward the infrared sensor 10. The first infrared light source 20 is located outside the case 60 and to be opposed to the infrared transmitting portion 64.

The first infrared light source 20 is located to be opposed to the infrared sensor 10 in the vehicle width direction W. The first infrared light source 20 is mounted on the substrate 72. The substrate 72 is electrically connected to the substrate 71 via the cable 76.

An infrared transmission-type object detection system is configured by the first infrared light source 20 and the infrared sensor 10. The infrared transmission-type object detection system determines the presence or absence of an object on the basis of whether infrared light from an infrared light source is blocked by the object. The infrared transmission-type object detection system has a long detection distance and high detection position accuracy. Moreover, an opaque object can be detected regardless of the shape such as a thin plate shape, color, and material. Furthermore, the infrared transmission-type object detection system is characterized by being resistant to dirt and dust on a light emitting portion (infrared light source) and a light receiving portion (infrared sensor).

The second infrared light source 30 is a light emitter that emits infrared light. The second infrared light source 30 is located outside the case 60 and to be opposed to the infrared transmitting portion 62. The second infrared light source 30 is located in the rear direction R from the infrared sensor 10.

An infrared reflection-type object detection system is configured by the second infrared light source 30 and the infrared sensor 10. The infrared reflection-type object detection system determines the presence or absence of an object on the basis of the presence or absence of light obtained by reflecting infrared light from an infrared light source by the object. The infrared reflection-type object detection system requires only the second infrared light source 30 and the infrared sensor 10 arranged on only one side of the display 50 in the vehicle width direction W, and thus does not require a large space. Moreover, the infrared reflection-type object detection system does not require the optical axis alignment, and is characterized by being capable of detecting a transparent object as long as the transparent object is a reflector. The reflection referred to herein includes not only regular reflection but also diffuse reflection.

The directivity of the infrared light emitted by the first infrared light source 20 is set to be higher than the directivity of the infrared light emitted by the second infrared light source 30. That is, the directivity angle of the infrared light emitted by the first infrared light source 20 is set to be smaller than the directivity angle of the infrared light emitted by the second infrared light source 30.

The infrared sensor 10 is a light receiver that receives infrared light. The infrared sensor 10 is located outside the case 60 and to be opposed to the infrared transmitting portion 63. The infrared sensor 10 senses the light intensity of the received infrared light, and outputs a sensing signal Se to the control unit 40.

As illustrated in FIG. 4, the infrared sensor 10 is located at the same height as the first infrared light source 20 in the up-down direction U, D, and is located in the down direction D from the second infrared light source 30. The infrared sensor 10 and the first infrared light source 20 are located corresponding to a lower end portion (gravity direction) of the emission surface 52a that is inclined with respect to the front-rear direction F, R. The lower end portion of the emission surface 52a is a region in which an object on the emission surface 52a is likely to gather due to the inertia force or the like of the vehicle 200.

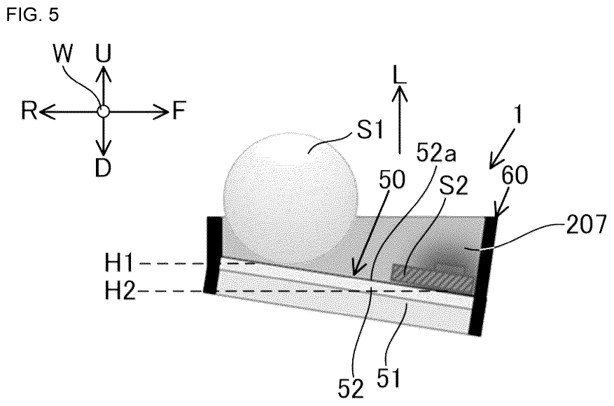

The second infrared light source 30 is provided corresponding to a position at a first height H1 (refer to FIG. 5) of the emission surface 52a whose height changes in the front-rear direction F, R. Moreover, the infrared sensor 10 and the first infrared light source 20 are provided corresponding to a position at a second height H2 (refer to FIG. 5), which is lower than the first height H1, of the emission surface 52a whose height changes in the front-rear direction F, R. The position at the first height H1 is near the highest position of the emission surface 52a. The position at the second height H2 is near the lowest position of the emission surface 52a.

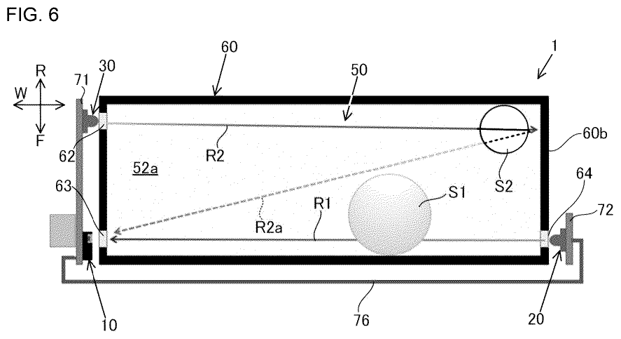

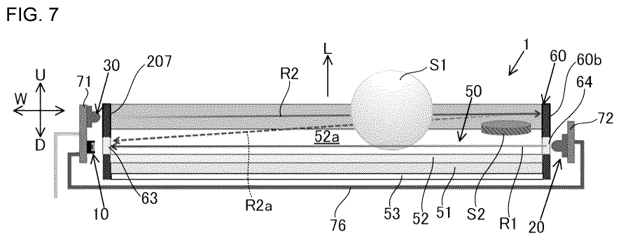

When an object does not exist between the infrared sensor 10 and the first infrared light source 20, the infrared sensor 10 directly receives infrared light R1 (refer to FIGS. 6 and 7) from the first infrared light source 20.

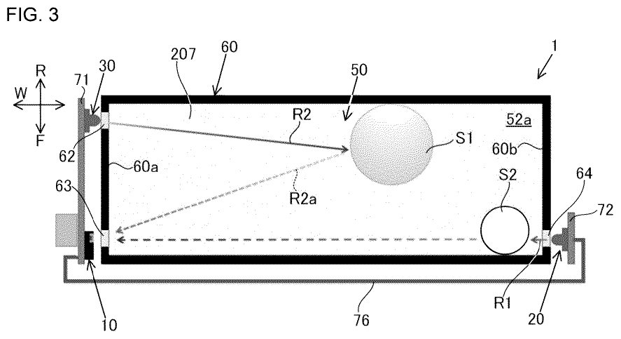

The infrared sensor 10 indirectly receives reflected infrared light R2a (refer to FIGS. 3 and 4) which is obtained by reflecting infrared light R2 (refer to FIGS. 3 and 4) from the second infrared light source 30 by the object S1.

As illustrated in FIG. 2, the infrared sensor 10 and the second infrared light source 30 are mounted on the common substrate 71. The substrate 71 is electrically connected to the substrate 73 on which the control unit 40 is mounted via the cable 75.

The control unit 40 includes a central processing unit (CPU), a graphics display controller (GDC), or the like. The control unit 40 includes a display control unit 41 that controls the display 50 and an object determination unit 42 that determines the presence or absence of an object on the emission surface 52a.

The object determination unit 42 performs control to emit the infrared light R1, R2 from the infrared light sources 20, 30 at different timings, and receives the sensing signal Se from the infrared sensor 10. The object determination unit 42 determines the presence or absence of an object on the basis of the received sensing signal Se. The determination processing will be described below.

When the object determination unit 42 determines that there is no object on the emission surface 52a, the display control unit 41 displays an image including vehicle information such as a vehicle speed on the display panel 51.

When the object determination unit 42 determines that there is an object on the emission surface 52a, the display control unit 41 displays a warning image on the display panel 51. The warning image includes information such as the presence of an object on the emission surface 52a or an inspection request at a car dealer. The warning image may be displayed together with the image including vehicle information. The warning image may be displayed only when an ignition of the vehicle 200 is turned on.

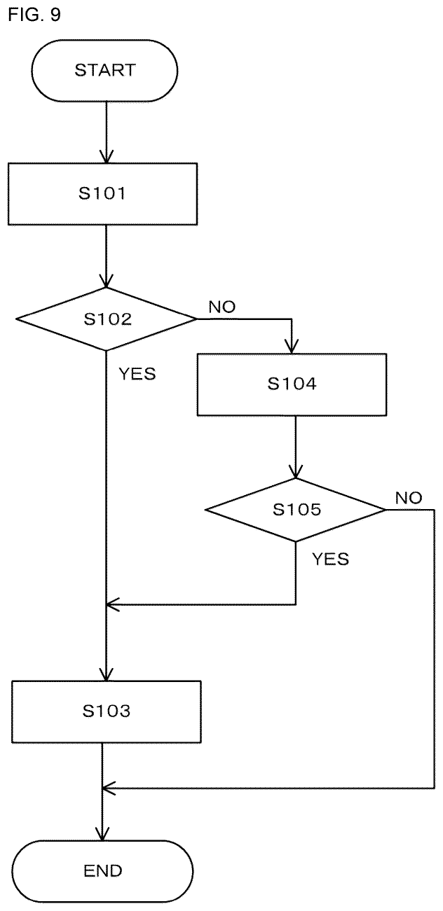

Next, a determination processing procedure of the object determination unit 42 will be described with reference to a flowchart of FIG. 9. The determination processing procedure is repeatedly executed while an image is displayed on the display panel 51.

First, the object determination unit 42 emits the infrared light R1 from the first infrared light source 20 (step S101).

Then, the object determination unit 42 determines whether an object exists on the emission surface 52a between the infrared sensor 10 and the first infrared light source 20 on the basis of the sensing signal Se from the infrared sensor 10 (step S102).

In step S102, as illustrated in FIGS. 3 to 5, when the infrared light R1 from the first infrared light source 20 is blocked by the object S2 and the infrared light R1 cannot be received via the infrared sensor 10, the object determination unit 42 determines that the object S2 exists on the emission surface 52a between the infrared sensor 10 and the first infrared light source 20 (step S102; YES).

When the object determination unit 42 determines that the object S2 exists (step S102; YES), the display control unit 41 displays a warning image on the display panel 51 (step S103), and ends the determination processing.

On the other hand, returning to step S102, as illustrated in FIG. 2, when the infrared light R1 is received from the first infrared light source 20 via the infrared sensor 10, the object determination unit 42 determines that an object does not exist on the emission surface 52a between the infrared sensor 10 and the first infrared light source 20 (step S102; NO). More specifically, the object determination unit 42 determines that an object does not exist when the light intensity of the infrared light indicated by the sensing signal Se is equal to or more than a first threshold value Th1. The first threshold value Th1 is set to a signal intensity between a received signal intensity at the infrared sensor 10 of the direct infrared light R1 from the first infrared light source 20 and a received signal intensity at the infrared sensor 10 when the infrared light R1 is blocked by an object.

When the object determination unit 42 determines that the object S2 does not exist (step S102; NO), the object determination unit 42 emits the infrared light R2 from the second infrared light source 30 (step S104).

Then, the object determination unit 42 determines whether an object exists on the emission surface 52a on the basis of the sensing signal Se from the infrared sensor 10 (step S105).

In step S105, as illustrated in FIGS. 3 to 5, when the reflected infrared light R2a obtained by reflecting the infrared light R2 from the second infrared light source 30 by the object S1 is received via the infrared sensor 10, the object determination unit 42 determines that the object S1 exists on the emission surface 52a (step S105; YES). More specifically, the object determination unit 42 determines that an object exists on the emission surface 52a when the light intensity of the infrared light indicated by the sensing signal Se is equal to or more than a second threshold value Th2.

As illustrated in FIGS. 3 and 4, when the reflected infrared light R2a obtained by reflecting the infrared light R2 from the second infrared light source 30 by the object S1 is received by the infrared sensor 10, the light intensity of the reflected infrared light R2a detected by the infrared sensor 10 is equal to or more than the second threshold value Th2. The second threshold value Th2 is set to a signal intensity between a received signal intensity at the infrared sensor 10 of the reflected infrared light R2a obtained by reflecting the infrared light R2 from the second infrared light source 30 by the object S1 and a received signal intensity at the infrared sensor 10 of reflected infrared light obtained by reflecting the infrared light R2 from the second infrared light source 30 by the side walls and infrared light that is incident through the windshield 201.

When the object determination unit 42 determines that the object S1 exists (step S105; YES), the display control unit 41 displays a warning image on the display panel 51 (step S103), and ends the determination processing.

On the other hand, returning to step S105, when the light intensity of the infrared light indicated by the sensing signal Se is less than the second threshold value Th2 after the infrared light R2 is emitted from the second infrared light source 30, the object determination unit 42 determines that an object does not exist on the emission surface 52a (step S105; NO), and ends the determination processing while maintaining the display of the image including vehicle information.

In a state where the objects S1, S2 are located on the emission surface 52a, the objects S1, S2 can reciprocate in the front-rear direction F, R on the emission surface 52a due to the inertia force or the like of the vehicle 200.

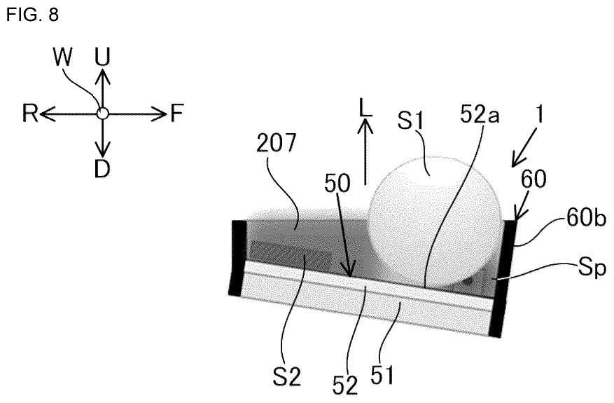

For example, as illustrated in FIGS. 6 to 8, when the spherical object S1 is located at an end portion on the emission surface 52a in the front direction F, the infrared light R1 from the first infrared light source 20 passes through a space Sp (refer to FIG. 8) between the outer peripheral surface of the object S1, the short side wall 60b, and the emission surface 52a. Thus, in this state, it cannot be determined that the object S1 is located on the emission surface 52a by the combination of the first infrared light source 20 and the infrared sensor 10, whereas it is determined that the object S1 is located on the emission surface 52a by the combination of the second infrared light source 30 and the infrared sensor 10. However, when the object S1 moves in the rear direction R on the emission surface 52a due to the inertia force or the like of the vehicle 200, as illustrated in FIGS. 3 to 5, the spherical object S1 is located at an end portion on the emission surface 52a in the rear direction R. Even in this state, as described above, it is determined that the object S1 is located on the emission surface 52a by the combination of the second infrared light source 30 and the infrared sensor 10.

In addition, for example, as illustrated in FIGS. 6 to 8, when the small object S2 is located at an end portion on the emission surface 52a in the rear direction R and near the short side wall 60b, it may become difficult to determine that the object S2 is located on the emission surface 52a by the combination of the second infrared light source 30 and the infrared sensor 10. However, when the object S2 moves in the front direction F on the emission surface 52a due to the inertia force or the like of the vehicle 200, as illustrated in FIGS. 3 to 5, the object S2 is located at an end portion on the emission surface 52a in the front direction F. In this state, as described above, it is determined that the object S2 is located on the emission surface 52a by the combination of the first infrared light source 20 and the infrared sensor 10. The combination of the first infrared light source 20 and the infrared sensor 10 enables detection of the object S2 with high accuracy even if the object S2 is thin or the object S2 is located near the short side walls 60a, 60b.

### Effects

According to the above-described embodiment, the following effects are achieved.

(1) A display device 1, which is an example of a vehicle projection display device, displays an image by projecting display light L from an emission port 207 onto a windshield 201, which is an example of a projection target member. The display device 1 includes: a translucent cover panel 52 through which the display light L passes, which changes a height with respect to a front-rear direction F, R of a vehicle 200, has an emission surface 52a that emits the display light L toward the windshield 201, and is formed in a plate shape for closing the emission port 207; first and second infrared light sources 20, 30 that emit infrared light R1, R2 along the emission surface 52a; and an infrared sensor 10 that can detect the infrared light R1 directly reaching from the first infrared light source 20 and reflected infrared light R2a obtained by reflecting the infrared light R2 from the second infrared light source 30 by an object S1 on the emission surface 52a. The second infrared light source 30 is arranged lateral to the emission surface 52a in a vehicle width direction W orthogonal to the front-rear direction F, R so as to be aligned with the infrared sensor 10 in the front-rear direction F, R, and is provided corresponding to a position at a first height H1 of the emission surface 52a in the front-rear direction F, R. The first infrared light source 20 and the infrared sensor 10 are located so as to be opposed to each other via the emission surface 52a in the vehicle width direction W, and are provided corresponding to a position at a second height H2, which is lower than the first height H1, of the emission surface 52a in the front-rear direction F, R.

According to this configuration, since the number of the infrared sensors 10 is smaller than the number of the infrared light sources 20, 30, the configuration can be simplified.

In addition, an object on the emission surface 52a is likely to be located between the first infrared light source 20 and the infrared sensor 10 which are low in height. Therefore, the infrared transmission-type object detection system with high detection accuracy, which is formed by the combination of the first infrared light source 20 and the infrared sensor 10, can be effectively utilized.

(2) The first infrared light source 20 emits the infrared light having a higher directivity than the infrared light from the second infrared light source 30.

According to this configuration, by combining the infrared light sources 20, 30 whose directivities are different from each other, it is possible to compensate for the disadvantages of the above-described infrared transmission-type and infrared reflection-type while combining the characteristics thereof.

The present disclosure is not limited by the above embodiment and drawings. Modifications (including deletion of components) may be made as appropriate without departing from the scope of the present disclosure. Examples of the modifications will be described below.

### Modifications

In the above-described embodiment, the display device 1 projects the display light L onto the light shielding portion 203 of the windshield 201. However, the present invention is not limited thereto, and the display device 1 may project the display light L onto the light transmitting portion 202 of the windshield 201. In this case, the projection image may be superimposed on the actual scenery.

In the above-described embodiment, the light shielding portion 203 of the windshield 201 may be omitted.

In the above-described embodiment, the display device 1 may project the display light L onto a dedicated combiner.

In the above-described embodiment, the object determination unit 42 may receive vehicle speed information from the outside and determine whether an object exists on the emission surface 52a in consideration of the vehicle speed. The object determination unit 42 may add, for example, a change in the vehicle speed, that is, the inertia force or the like being equal to or more than a predetermined value, as one of the conditions for determining that an object exists on the emission surface 52a. The predetermined value may be set to the inertia force or the like by which an object on the dashboard 205 may fall into the emission port 207.

In the above-described embodiment, the infrared transmitting portions 62, 63, 64 may be condenser lenses that condense infrared light passing therethrough.

The substrates 71, 72, 73 in the above-described embodiment can be omitted.

In the above-described embodiment, the infrared light sources 20, 30 and the infrared sensor 10 may be mounted on a control board below the display 50. In this case, a light guide member may be provided between the infrared light sources 20, 30 and the infrared sensor 10 and the lateral side of the emission surface 52a.

In the above-described embodiment, the first infrared light source 20 emits the infrared light having a higher directivity than the infrared light from the second infrared light source 30. However, the present invention is not limited thereto, and the first infrared light source 20 may emit infrared light having a lower directivity than the infrared light from the second infrared light source 30 or infrared light having the same directivity as the infrared light from the second infrared light source 30.

In the above-described embodiment, the number of the second infrared light sources 30 in the infrared reflection-type object detection system is one, but a plurality of second infrared light sources 30 may be provided. For example, the plurality of (for example, two) second infrared light sources 30 may be aligned with each other in the front-rear direction F, R along the outer surface of the short side wall 60. The infrared light sources may have the same or different directivities and wavelength characteristics. A threshold value used for determination may be individually set for each infrared light source. In one detection operation, the plurality of infrared light sources may be controlled to emit light or may be controlled to emit light in a time-division manner.

The infrared sensor 10 and the second infrared light source 30, and the first infrared light source 20 are arranged on both sides of the emission surface 52a in the vehicle width direction W, but may be arranged on both sides of the emission surface 52a in the front-rear direction F, R.

The infrared transmitting portions 62, 63, 64 in the above-described embodiment may be formed as light guide members. The infrared transmitting portions 62, 63, 64 may be omitted. In this case, a through hole of the case 60 is formed so as to allow infrared light to pass therethrough.

In the above-described embodiment, the emission surface 52a of the display panel 51 is configured to be directly opposed to the projection target member (windshield 201). However, the present invention is not limited thereto, and a cover member formed in a plate shape from a translucent resin or glass may be provided between the display panel 51 and the projection target member. The infrared sensor 10 and the infrared light sources 20, 30 may be arranged so as to be able to determine the presence or absence of an object on the emission surface of the cover member opposed to the projection target member.

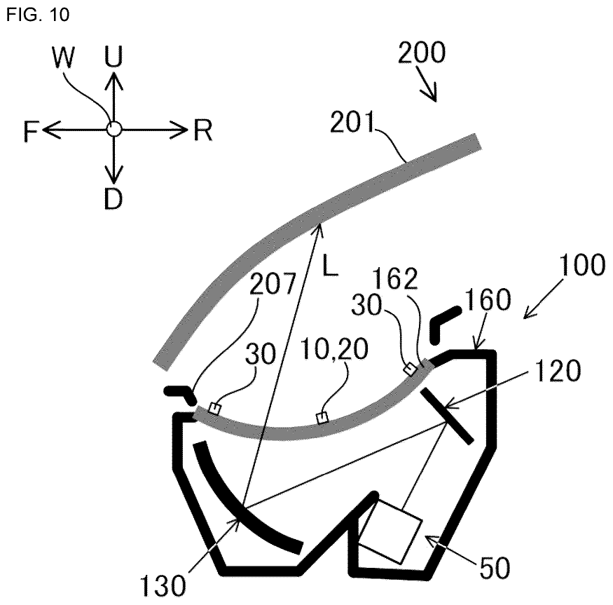

As a modification thereof, for example, as illustrated in FIG. 10, a head-up display (HUD) device 100 as a vehicle projection display device includes a HUD case 160, a cover member 162, the display 50, and mirrors 120, 130. The mirrors 120, 130 are optical relays that guide the display light L from the display 50 to the projection target member. The HUD case 160 houses the display 50 and the like, and an opening is formed at a position opposed to the windshield 201. The translucent cover member 162 through which the display light L passes is fitted into the opening. The cover member 162 has a plate shape that is curved in a concave shape while being inclined in the front-rear direction F, R. The infrared sensor 10 and the infrared light sources 20, 30 are arranged so as to be able to determine the presence or absence of an object on the emission surface (upper surface) of the cover member 162. The cover member 162 may be the lowest in the vicinity of the center in the front-rear direction F, R. In this case, the infrared sensor 10 and the first infrared light source 20 may be arranged in the vicinity of the center, and the second infrared light sources 30 may be arranged on both sides of the vicinity of the center in the front-rear direction F, R.

In addition, the emission surface is formed to have the same height in the vehicle width direction W, but may be formed to have different heights in the vehicle width direction W. In this case, the infrared sensor 10 and the first infrared light source 20 may be arranged at the lowest position in the front-rear direction F, R and in the vehicle width direction W.

In the above-described embodiment, the display device 1 is of a type including a liquid crystal panel. However, the display device 1 may be of any type as long as the display device 1 has a configuration having an emission surface that emits the display light L, and may be of a type using an organic EL panel, a micro electro mechanical systems (MEMS), or a digital micromirror device (DMD).

In the determination processing procedure of the above-described embodiment, the emission order of the infrared light R1, R2 may be reversed.

The above-described embodiment shows an example in which, when the object determination unit 42 determines that there is no object on the emission surface 52a, the display control unit 41 displays an image including vehicle information such as a vehicle speed on the display panel 51. However, even when the object determination unit 42 determines that there is no object on the emission surface 52a, if the display control unit 41 has displayed a warning image immediately before the determination, the display may be maintained.

For example, an object located on the emission surface 52a may be displaced by receiving the inertia force or the like due to traveling of the vehicle 200 or the like. Thus, even when the object determination unit 42 determines that there is no object on the emission surface 52a, there is a possibility that an object is only temporarily outside the detection range. Therefore, even when the object determination unit 42 determines that there is no object on the emission surface 52a, if the display control unit 41 has displayed a warning image immediately before the determination, the display may be maintained.

In particular, when the vehicle 200 is traveling, this possibility increases. Thus, the control for maintaining the display of the immediately preceding warning image may be performed only when the vehicle 200 is traveling (that is, except when the vehicle is parked or stopped).

In such a case, before step S103 of the flowchart illustrated in FIG. 9, a step in which the object determination unit 42 holds the determination result indicating that the object S2 exists and the display control unit 41 determines whether to display the warning image or whether to change the presence or absence of display of the immediately preceding warning image may be executed.

In the above-described embodiment, the object determination unit 42 determines the presence or absence of an object on the emission surface 52a. However, the object determination unit 42 may determine the presence or absence of an object on the basis of a result obtained by measuring the light intensity a plurality of times. Measuring the light intensity a plurality of times (that is, increasing the number of times of sampling) reduces the possibility of erroneous determination due to disturbance and improves the accuracy of the determination result.

### REFERENCE SIGNS LIST

1 display device
10 infrared sensor
20 first infrared light source
30 second infrared light source
40 control unit
41 display control unit
42 object determination unit
50 display
51 display panel
52 cover panel
52a emission surface
53 backlight
60 case
60a, 60b short side wall
60c, 60d long side wall
62, 63, 64 infrared transmitting portion
71, 72, 73 substrate
75, 76 cable
100 head-up display device
120, 130 mirror
160 HUD case
162 cover member
200 vehicle
201 windshield
202 light transmitting portion
203 light shielding portion
205 dashboard
207 emission port
U up direction
D down direction
F front direction
R rear direction
W vehicle width direction
L display light
R1, R2 infrared light
R2a reflected infrared light
S1, S2 object
Se sensing signal
Th1 first threshold value
Th2 second threshold value
Sp space
Us viewer

1. A vehicle projection display device that displays an image by projecting display light from an emission port onto a projection target member, comprising:
a translucent cover panel through which the display light passes, which changes a height with respect to a front-rear direction of a vehicle, has an emission surface that emits the display light toward the projection target member, and is formed in a plate shape for closing the emission port;
first and second infrared light sources that emit infrared light along the emission surface; and
an infrared sensor that can detect the infrared light directly reaching from the first infrared light source and reflected infrared light obtained by reflecting the infrared light from the second infrared light source by an object on the emission surface, wherein
the second infrared light source is arranged lateral to the emission surface in a width direction orthogonal to the front-rear direction so as to be aligned with the infrared sensor in the front-rear direction, and is provided corresponding to a position at a first height of the emission surface in the front-rear direction, and
the first infrared light source and the infrared sensor are located so as to be opposed to each other via the emission surface in the width direction, and are provided corresponding to a position at a second height, which is lower than the first height, of the emission surface in the front-rear direction.

2. The vehicle projection display device according to claim 1, wherein
the first infrared light source emits the infrared light having a higher directivity than the infrared light from the second infrared light source.
